(19) United States
(12) Patent Application Publication
(10) Pub. No.: US 2004/0123489 A1
(43) Pub. Date: Jul. 1, 2004

(54) Thermal protection of fabric article treating device

(75) Inventors: Eugene Joseph Pancheri, Cincinnati, OH (US); Janine Morgens Strang, Deer Park, OH (US); Andrew Julian Wnuk, Wyoming, OH (US); Christopher Lawrence Smith, Liberty Township, OH (US); Brian Joseph Roselle, Fairfield, OH (US); Dean Larry DuVal, Lebanon, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/697,734

(22) Filed: Oct. 29, 2003

Related U.S. Application Data
(63) Continuation-in-part of application No. 10/418,595, filed on Apr. 17, 2003.
(60) Provisional application No. 60/374,601, filed on Apr. 22, 2002.
(60) Provisional application No. 60/426,438, filed on Nov. 14, 2002.

(51) Int. Cl. F26B 11/02

(52) U.S. Cl. 34/597

(57) ABSTRACT

A fabric article treating device for use with a fabric article drying appliance. The fabric article treating device dispenses a benefit composition into a chamber so as to provide benefits to fabric articles contained within the fabric article drying appliance. The fabric article treating device comprises a thermal protection means for extending the operating life of one or more components of the device which are thermally sensitive.

### CROSS REFERENCE TO RELATED APPLICATIONS

This application is a continuation-in-part of U.S. application Ser. No. 10/418,595 filed Apr. 17, 2003; which claims the benefit of U.S. Provisional Application Serial No. 60/374,601, filed Apr. 22, 2002; and U.S. Provisional Application Serial No. 60/426,438, filed Nov. 14, 2002.

### FIELD OF THE INVENTION

The present invention relates to a fabric article treating device for use with a fabric article drying appliance (a non-limiting example of which includes a clothes dryer). The treating device may be a stand-alone discrete device. The device may be removably attached to the fabric article drying appliance. The treating device dispenses a benefit composition through a nozzle that directs the benefit composition into a chamber. The treating device comprises: 1) a power source, 2) one or more sources of a benefit composition, 3) a dispensing means, and 4) a means for thermally protecting temperature sensitive components useful in such a device. More particularly, the present invention relates to a fabric article treating device wherein the thermal protection means provides a means to extend battery and/or electronics life and the life of other components which are temperature sensitive.

### BACKGROUND OF THE INVENTION

Fabric article treating methods and/or devices have been evolving over the past 40 years. Conventional fabric article drying appliances such as clothes dryers typically have the electronic components located within the control panel of the appliance (away from the heat).

U.S. Pat. No. 4,891,890 purports to describe a spraying device powered by batteries. However, one particular drawback of this device is the high discharge rate of batteries at the elevated temperatures of a domestic clothes dryer (i.e.; domestic clothes dryers commonly have operating air temperatures upwards of about 75° C.). According to data from the Eveready Battery Co., Inc. life expectancy of an alkaline battery can drop dramatically starting at just 40° C. Other readily available battery types have similar discharge profiles. This high discharge rate under typical clothes dryer operating temperatures necessitates frequent replacement and/or recharging of the batteries, which causes increased cost and/or inconvenience to a user of this device.

Thus it would be desirable to provide a fabric article treating device wherein the life of temperature sensitive components are extended through a thermal protection means. The thermal protection means protects the batteries and/or other heat sensitive components from the elevated temperatures generally found within fabric article drying appliances.

### SUMMARY OF THE INVENTION

The present invention relates to a fabric article treating device for dispensing a benefit composition which includes a means for thermal protection of one or more components of the device.

The present invention also relates to a system for treating fabrics wherein the system includes a fabric article treating device and a fabric article drying appliance. The fabric article treating device of the system includes a means for thermal protection of the components associated with the treating device.

The present invention further relates to a method for treating fabrics wherein the method includes a fabric article drying appliance and a fabric article treating device wherein the treating device includes a thermal protection means.

### BRIEF DESCRIPTION OF THE DRAWINGS

FIG. 1 is a front view of a device made according to the present invention

FIG. 2 is a cross-sectional side view taken along line 2-2 of the device of FIG. 1.

FIG. 3 is a cross-sectional side view of an alternate embodiment of the device of the present invention taken along line 2-2 of FIG. 1.

FIG. 4 is a cross-sectional side view of an alternate embodiment of the device of the present invention taken along line 2-2 of FIG. 1.

FIG. 5 is a cross-sectional side view of an alternate embodiment of the device of the present invention taken along line 2-2 of FIG. 1.

FIG. 6 is a cross-sectional side view of an alternate embodiment taken along line 2-2 of FIG. 1.

FIG. 7 depicts one embodiment of a system for treating fabric articles in accordance with the present invention.

FIG. 8 depicts an alternate embodiment of a system for treating fabric articles in accordance with the present invention.

FIG. 9 is an exploded view of a device according to an alternate embodiment of the present invention.

FIG. 10 illustrates an exploded view of a device according to an alternate embodiment of the present invention.

FIG. 11 is a perspective view of another embodiment of a fabric article treating device made in accordance with the present invention.

FIG. 12 is a perspective view from the opposite angle of the fabric article treating device of FIG. 11.

FIG. 13 is an elevational view from one side in partial cross-section of the fabric article treating device of FIG. 11 taken along line 3-3 of FIG. 11.

FIG. 14 is an elevational view from one side in partial cross-section of the interior housing portion of the fabric article treating device of FIG. 11 taken along line 4-4 of FIG. 11.

FIG. 15 is a schematic illustrating thermoelectric cooling which may be used in accordance with the present invention.

### DETAILED DESCRIPTION OF THE INVENTION

Definitions

The phrase “fabric article treating system” as used herein means a fabric article drying appliance, a non-limiting example of which includes a conventional clothes dryer and/or modifications thereof. The fabric article treating system also includes a fabric article treating device which may be a discrete stand-alone device in relation to the fabric article drying appliance, it may be integrated into the fabric article drying appliance, or the device may be integrated into a removably attached portion of the fabric article drying appliance, a non-limiting example of which includes a closure structure of the drying appliance. Furthermore, the fabric article treating system additionally includes one or more benefit composition(s).

“Fabric article” as used herein means any article that is customarily cleaned in a conventional laundry process or in a dry cleaning process. The term encompasses articles of fabric including but not limited to: clothing, linen, draperies, clothing accessories, leather, floor coverings, and the like. The term also encompasses other items made in whole or in part of fabric, such as tote bags, furniture covers, tarpaulins, shoes, and the like.

“Suitable for use” as used herein relates to a functionality of one or more components of the device and/or system such that the replacement component(s) retain a basic functionality within the fabric article treating system. In a non-limiting example, a closure structure that is suitable for use in a fabric article drying appliance would still retain the function of providing closure, although other features of the closure structure may differ from the original component.

As used herein, the term “benefit composition” refers to a composition used to deliver a benefit to a fabric article. Non-limiting examples of materials and mixtures thereof which can comprise the benefit composition include: water, softening agents, crispening agents, perfume, water/stain repellents, refreshing agents, antistatic agents, antimicrobial agents, durable press agents, wrinkle resistant agents, odor resistance agents, abrasion resistance agents, solvents, and combinations thereof.

“Conduit” as used herein means a channel or pathway through which a benefit composition is conveyed. Non-limiting examples of conduits include: tubing, piping, channels, and the like which are capable of conveying a composition from point to point within the device. For example the conduit may transfer the benefit composition from the source of the benefit composition to a dispensing means. Additionally, the conduit may convey the benefit composition from the dispensing means to a point of discharge, such as a nozzle, an orifice, or the like.

The phrase “within the thermal path” as used herein means any location between a source of heat and one or more components of the device associated with the benefit composition and/or the benefit composition itself, including direct and/or indirect contact with one or more components. Non-limiting examples of sources of heat include: a fabric article drying appliance, an exothermic reaction, a heating coil, thermoelectric means, and the like.

The phrase “insulating material” as used herein is used to describe any material that has a thermal conductivity, or k value, of about 0 to about 5 W/m*° C. at 25° C. The thermal conductivity of the material may be determined by a guarded hot plate method as described in ASTM method C177-97 entitled “Standard Test Method for Steady-State Heat Flux Measurements and Thermal Transmission Properties by Means of the Guarded-Hot-Plate Apparatus” or other suitable method known to those of ordinary skill in the art.

The phrase “heat sensitive” and “temperature sensitive” as used herein refers to any component(s) associated with the fabric article treating device and/or treating system which may be subject to a deleterious effect from exposure to a temperature encountered during the fabric article treating process. Non-limiting examples of heat sensitive components associated with the fabric article treating device include: batteries, electronics, sensors, benefit composition, materials of construction of device component(s), and the like.

Fabric Article Treating Device

The present invention relates to a fabric article treating device which comprises a thermal protection means within the thermal path between the fabric article treating device and a fabric article drying appliance so as to provide thermal protection to one or more components associated with the fabric article treating device. The device as used herein includes any component(s) associated with the device that is capable of delivering a benefit composition to a fabric article drying appliance and/or fabric article(s) present in the appliance. The device can be a stand-alone discrete device or it may be integral with the fabric article drying appliance. Furthermore the device may be both discrete and integral, for example it may be incorporated, into a closure structure (a non-limiting example of which is a door) suitable for use with a fabric article drying appliance. The fabric article treating device may be substantially or totally independent of the fabric article drying appliance controls.

The term “door,” as used herein, represents a movable closure structure that allows a person to access an interior volume of the drying appliance, and can be of virtually any physical form that will enable such access. The door “closure structure” could be a lid on the upper surface of the dryer appliance, or a hatch of some sort, or the like.

Thermal Protection Means

The fabric article treating device additionally comprises one or more thermal protection means disposed within the thermal path between the fabric article drying appliance and one or more components associated with the fabric article treating device. The thermal protection means provides thermal protection to one or more components of the device. The thermal protection means may comprise insulating materials, heat transfer materials, phase transition materials, thermoelectric cooling, or combinations thereof. While it may be advantageous to protect the entire fabric article device with a thermal protection means, it may also be beneficial from an economical standpoint to protect selected components associated with the device, non-limiting examples of which include: the power source, benefit composition, electronics, or combinations thereof.

A. Insulating Materials:

In one embodiment of the present invention, thermal protection may be provided by utilizing an insulating material within the thermal path between the fabric article drying appliance and one or more components associated with the device. Examples of insulating material include but are not limited to a casing which encompasses the device, or a material applied exterior to one or more components associated with the device (non-limiting examples of such components include the batteries, electronics, benefit composition, or combinations thereof). Additionally, an insulating material may be multi-layered, and comprise a thermal protection material such as air or polystyrene disposed therebetween.

Preferred insulating materials will have a thermal conductivity, or k value, of about 0 to about 5 W/m*° C. at 25° C. Non-limiting examples of such materials include: thermoplastic polymeric foams, crosslinked thermoplastic foams, thermosetting polymeric foams, syntactic foams, ceramic foams, particulate insulators, fibrous insulators, honeycomb structures, naturally derived materials based on lignocellulosic substances, thermoplastic materials, thermoset materials, and composite structures comprising one or more insulating materials. The insulating material may be in the form of, inter alia, a solid or a foam. An advantage to using a foam insulating material is the relatively light weight compared to the non-foamed counterpart. Typical foam insulating materials will have a cell size from about 0.1 μm to about 2000 μm, although larger cell sizes may be used. Solid insulating materials may be advantageous when it is desired to provide both an insulating material and a casing to one or more components of the device. A suitable thickness for the insulating material(s), foamed or solid, is from about 1 mm to about 50 mm, more preferably from about 1.5 mm to about 30 mm.

“Thermoplastic” as used herein, refers to a polymeric material that can be repeatedly (i.e.; more than once) softened by increases in temperature, and hardened by decreasing the temperature. The thermoplastic may be in the form of a solid or a foam. Thermoplastic polymeric foams may include, but are not limited to: expanded polystyrene, polyethylene, polypropylene, polyvinylchloride, and polycarbonate. Non-limiting examples of crosslinked thermoplastic foams include: polyethylene, polyethylene copolymers, and polyvinylchloride. Non-limiting examples of solid thermoplastic materials include: polycarbonates, poly(ethylene terephthalate), polyethylene (high density and low density), polyimide, polypropylene, and the like. One suitable thermoplastic material is a high density polyethylene, under the tradename of Quadrant EPP Cestilene™ HD 500 Polyethylene, which may be obtained from Quadrant Engineering Plastic Products of Reading, Pa.

“Thermoset ”as used herein, relates to a polymeric material that has undergone a chemical reaction and in general cannot be returned to its original state by heating. The thermoset plastic may be in the form of a solid material, or a foam. Non-limiting examples of thermoset polymeric foams include: expanded polyurethane, epoxy, phenolic, melamine-formaldehyde, urea-formaldehyde, natural rubber, silicone rubber, synthetic rubbers, and the like. Solid thermoset materials include, but are not limited to: polyimides, polyurethanes, and the like. A suitable polyurethane thermoset insulating material may be obtained from Cytech Industries, Inc. of Olean, N.Y. under the tradename of Conathane® RN 1501. A suitable polyimide thermoset material may be obtained from Albany International of Mansfield, Mass. under the tradename of Pyropel® HD Plate.

Ceramic foams are also useful as insulating materials, and typically have a lighter weight than their non-foamed counterpart. Suitable ceramic foams include, but are not limited to: expanded glass, silica (e.g. silica aerogels), alumina, and magnesia. A suitable silica aerogel is available under the tradename of Pyrogel®, from Aspen Aerogels, Inc. of Marlborough, Mass.

Syntactic foams are generally produced by dispersing hollow spheres of glass or plastic in a polymer matrix, and are also useful as insulating materials. The polymer matrix may include, but is not limited to: epoxy, phenolic materials, and the like. A suitable example of a cyanate ester syntactic foam is available under the tradename of BryteCor™ EX-1541 from Bryte Technologies, Inc. of Morgan Hill, Calif.

Other insulating materials may be particulate, fibrous, or naturally derived materials based on lingocellulosic substances. Non-limiting examples of particulate insulators include asbestos, diatomaceous earth, pearlite, and hollow glass microspheres. Fibrous insulation materials include, but are not limited to: felt, wool, glass fiber, rock wool, and kapok. A suitable fibrous insulation material may be obtained from Albany International of Mansfield, Mass. under the tradename of Pyropel®; which includes the MD and LD series such as MD-50, MD-18, MD-30, MD-60, MD-12, and LD-6. Non-limiting examples of naturally derived materials based on lignocellulosic substances include wood, particle board, corkboard, granulated cork, sawdust, wood shavings, and corrugated paper.

As indicated above, the insulating material may be a casing of the fabric article treating device, or a material applied exterior to one or more components associated with the fabric article treating device such as the batteries, electronics, benefit composition, or combinations thereof. One insulating material may be used, or a plurality of insulating materials may be used. The insulating material(s) may be in the form of a solid, a foam, a gas, a vacuum, and/or a liquid.

In a variant of this embodiment, the insulating material may be coated, placed, or adhered on the exterior surface of a non-insulating material. A non-limiting example of a coated insulating material is a paint containing ceramic particles, which can be obtained from Hy-Tech of Melbourne, Fla. under the tradename of Insul-Seale®. A suitable thickness for the coating is from about 0.1 mm to about 10 mm.

In another variation of the present invention, the thermal protection means may comprise multiple layers of non-insulating material with an insulating material disposed therebetween. In this variation, the thermal protection means comprises at least three layers, with the first and second layer in exterior relation to the third layer. The first and second layers may be constructed of a non-insulating material, while the third layer is constructed of an insulating material. Suitable examples of insulating materials include, but are not limited to: air, polyolefin foams, polystyrene, and the like. Preferred thickness for the third layer is from about 1 mm to about 50 mm, more preferably from about 1.5 mm to about 30 mm.

In still yet another variation of the present invention, the thermal protection means may comprise multiple layers of non-insulating material and/or insulating material, with a vacuum present between the two or more layers. In this embodiment, the two or more layers may be sealed, in order to contain the vacuum.

B. Phase Transition Materials:

In another embodiment of the present invention, thermal protection may also be provided by utilizing a phase transition material within the thermal path between the fabric article drying appliance and one or more components of the device. As used herein, “phase transition material” refers to a material which has the ability to absorb heat without changing temperature by changing it's physical phase, for example from a solid phase to a liquid phase. The casing may be constructed of a phase transition material, a phase transition material and an insulating material, a non-insulating material and a phase transition material, or combinations thereof whereby the casing surrounds one or more heat sensitive components of the device thereby providing a thermally protective benefit.

Additionally, the device may comprise more than one phase transition material, providing thermal protection at differing temperature ranges. The phase transition material can comprise from about 0.1% to about 90% by weight of the device and preferably from about 0.2% to about 80% by weight of the device. Suitable phase transition materials are those materials having a melting point (for pure compounds) or glass transition temperature (for polymeric compounds) in the range from about 25° C. to about 100° C. Non-limiting examples of such materials include: 2,2,4-trimethyl-1,3-pentanediol; polyethylene glycols (with a weight average molecular weight distribution of about 1,500 to about 10,000 daltons) including but not limited to PEG 1500, PEG 4600, PEG 8000, and PEG 10,000; 1-9-nonanediol, CaCl₂*6H₂O; NaSO₄*10H₂O; salt hydrates; paraffins, beeswax, or combinations thereof. Suitable paraffin phase transition materials include those commercially available from Frisby Technologies of Winston Salem, N.C. sold under the trade name of Thermasorb® non-limiting examples of which include Thermasorb® 83, Thermasorb® 95, Thermasorb® 122, Thermasorb® 143, Thermasorb® 175, and Thermasorb® 215.

The phase transition material may be contained in a flexible and/or rigid container. Examples of flexible containers include but are not limited to a pouch wherein the phase transition material, which generally starts off as a solid at room temperature, is typically in a granular or pellet form. The phase transition material is placed in the pouch, and subsequently sealed by some suitable method including but not limited to heat sealing, twist tying, etc. The pouch can then be positioned so that it either surrounds the heat sensitive component, surrounds the outer casing of a heat sensitive component, or is positioned within the outer casing of a heat sensitive component. If the flexible container is positioned within the outer casing, the outer casing may be constructed of an insulative material as heretofore described.

In alternate embodiments, the phase transition material may be heated until in liquid form and poured into the pouch where it is subsequently sealed.

Rigid containers may include a dual walled container surrounding one or more heat sensitive components with a phase transition material disposed between the two walls. The rigid wall may for example comprise part of the outer casing of the fabric article treating device, or it may be a separate compartment within the device, yet surrounding one or more thermally sensitive components. It may be filled with a granular or pelletized phase transition material, or the phase transition material may be heated until in liquid form, and poured within the casing.

Suitable container materials for phase transition materials include, but are not limited to: polypropylene, polyvinyl acetate, polyethylene, polyurethane, polyvinyl chloride, and the like. The thickness of flexible container materials may be from about 0.1 mm to about 30 mm. The thickness of rigid container materials may be from about 5 mm to about 30 mm.

C. Heat Transfer Liquids

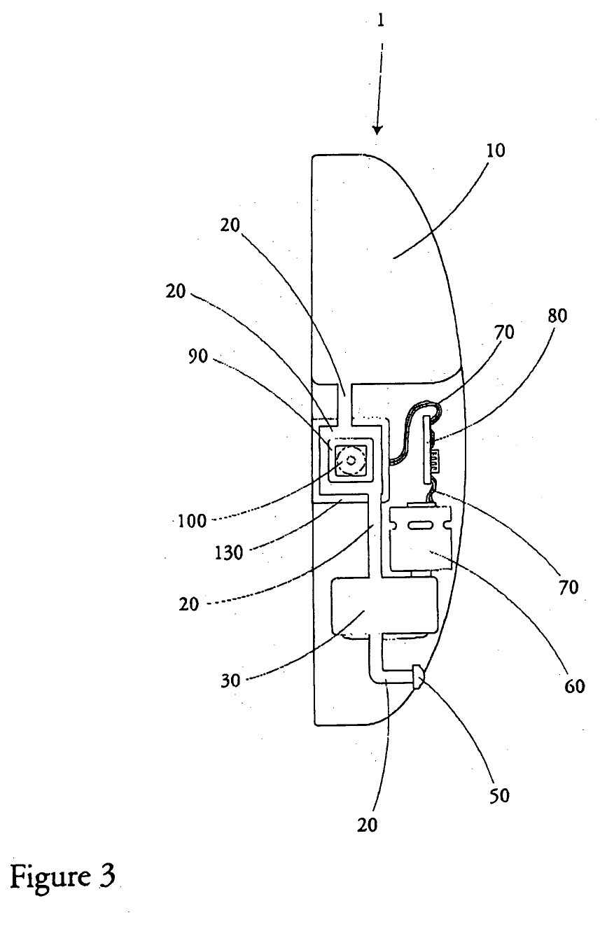

In still yet another embodiment of the present invention, as shown in FIG. 3, thermal protection may be provided by means of a heat transfer liquid which is conveyed in a conduit 20 in thermal communication with a casing 90 surrounding one or more heat sensitive components of the device. As used herein, “heat transfer liquid” refers to material which has a thermal conductivity or k value, of about 20 W/m*° C. or greater, and the phrase “in thermal communication” as used herein refers to a material which has a thermal effect upon one or more objects. Non-limiting examples of thermal effects include insulating effects, heat transfer effects, temperature change, and the like.

The benefit composition may be further stored in a cold environment, such as a household refrigerator, immediately prior to use then subsequently dispensed into the reservoir 10 to maximize the cooling benefit. In a variant of this embodiment, the benefit composition may have one or more multiple benefit ingredients, wherein the benefit ingredient has a k value of from about 20 W/m*° C. or greater to provide heat transfer and further yet provides a sensory benefit to the clothing. A non-limiting example of such an ingredient would be ethylene glycol, which provides both a heat transfer benefit as well as a softening and de-wrinkling benefit to the fabric article(s).

The benefit composition may include water, which by itself is an effective heat transfer agent. Water in some instances may comprise about 50% of the benefit composition. The benefit composition may comprise a heat transfer agent which additionally provides a sensory benefit such as softening. Non-limiting examples of such heat transfer liquids are ethylene glycol, triethylene glycol, polyethylene glycols, propylene glycols, and the like. These types of heat transfer agents will have a thermal conductivity, or k value, of about 20 W/m*° C. or greater. Also suitable are silicone heat transfer liquids, for example dimethyl polysiloxanes, which depending on the chain length can withstand temperatures of up to 260° C. A suitable heat transfer fluid can be obtained from Dow Chemical of Midland, Mich. under the tradename of HD Ethylene Glycol Heat Trans Fluid 50/50 which comprises a 50/50 mixture of water and ethylene glycol.

D. Thermoelectric Cooling

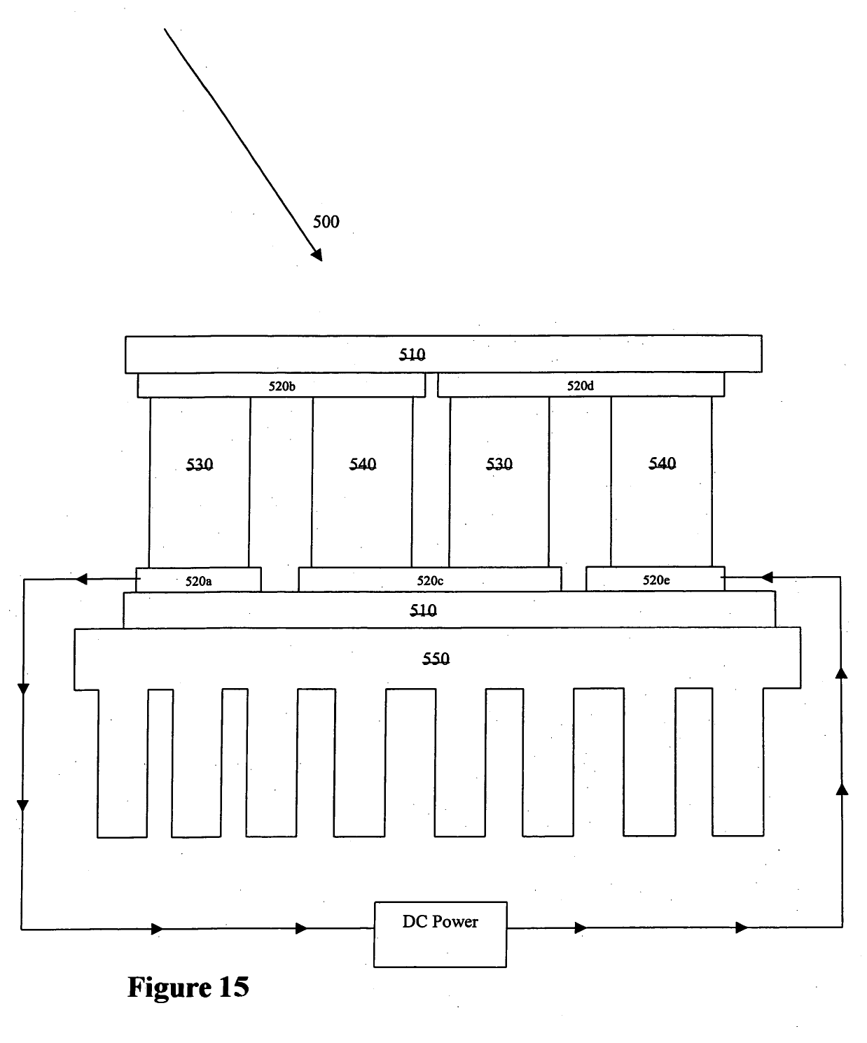

The thermal protection means may also comprise thermoelectric cooling, such as that achieved by the Peltier Effect. In general, the Peltier Effect/Peltier Cooling may be achieved by applying voltage to a module whereby heat is moved from one side of the module to another by electron movement. Without wishing to be bound by theory, it is believed that the Peltier Effect operates in the following manner as illustrated by the schematic diagram of FIG. 15: 1) a module 500 comprises at least one conducting material which is preferably a negative semi-conductor material 530, and at least one dissimilar conducting material which is preferably a positive semi-conductor material 540, which are connected electrically in series yet thermally in parallel, and are sandwiched between two ceramic substrates 510 which are positioned between a component(s) to be cooled and a heat sink 550; 2) the application of DC power to an electrical interconnect 520e cause electrons to flow to a positively doped semi-conductor material 540, which absorbs heat at an electrical connection 520d between the component to be cooled and the junction between the positively doped semiconductor material 540 and the negatively doped semiconductor material 530; 3) the electrons then flow through the negatively doped semi-conductor material 530 to an electrical connection 520c whereby heat is transferred to a second junction between the negatively doped semi-conductor material 530 and to another positively doped semi-conductor material 540; and 4) the heat is transferred from this second junction 520c to the heat sink 550, thereby transferring heat away from the component to be cooled.

Each module 500 for the Peltier Effect is constructed of at least one conducting material and another dissimilar conducting material. While the conducting materials may comprise different metals, in preferred embodiments the module 500 comprises at least one negatively doped semi-conductor material 530 and at least one positively doped semi-conductor material 540. The negatively and positively doped semi-conductor materials are connected electrically in series, yet thermally in parallel. Furthermore, the semi-conductors (540 and 530) and their electrical interconnects 520 are bridged between two ceramic substrates 510. The first ceramic substrate 510 is in thermal communication with both the component(s) to be cooled and the semi-conductor materials (540 and 530). The second ceramic substrate 510 is in thermal communication with the semi-conductor materials (540 and 530) and the heat sink 550. The heat sink 550 is further in thermal communication with the interior of the fabric article drying appliance (not shown), whereupon application of current to the semi-conductor materials (540 and 530) the accumulated heat is dissipated into the environment of the fabric article drying appliance and/or on a cooler surface. More than one module 500 may be used for a greater cooling effect, if stacked in parallel.

In general, the semi-conductor material is often, but not always, an alloy of bismuth telluride, lead telluride, silicon germanium, and/or bismuth antimony. The semi-conductor material may comprise a crystalline bismuth telluride, of both the P-type and N-type in equal and discrete proportions, although other ratios are also effective. As used herein, “N-type” semi-conductors material are of the negative type, doped with an excess of electrons than needed to create a perfect molecular lattice structure; whereas “P-type” semi-conductor materials are of the positive type, doped with a deficit of electrons needed to create a perfect molecular lattice structure. While not wishing to be bound by theory, it is believed that the extra electrons of the N-type material and the “missing” electrons (or holes) from the P-type materials facilitate the transfer of heat energy from end of the semi-conductor material to another.

The heat sink 550 is typically finned, in a manner such that the surface area of the material is maximized. The heat sink may be constructed of aluminum, copper, silver, and the like, although other conductive materials may also be used.

The DC power source may be any power source, such as a source of household current, batteries, and the like. In general, the power applied to the module may be about 12V, although higher values may be used if a greater cooling effect is desired.

One suitable example of a thermoelectric cooler utilizing the Peltier Effect is model 6302/127/060AX, which may be obtained from Ferrotec America Corporation of Nashua, N.H.

Power Source

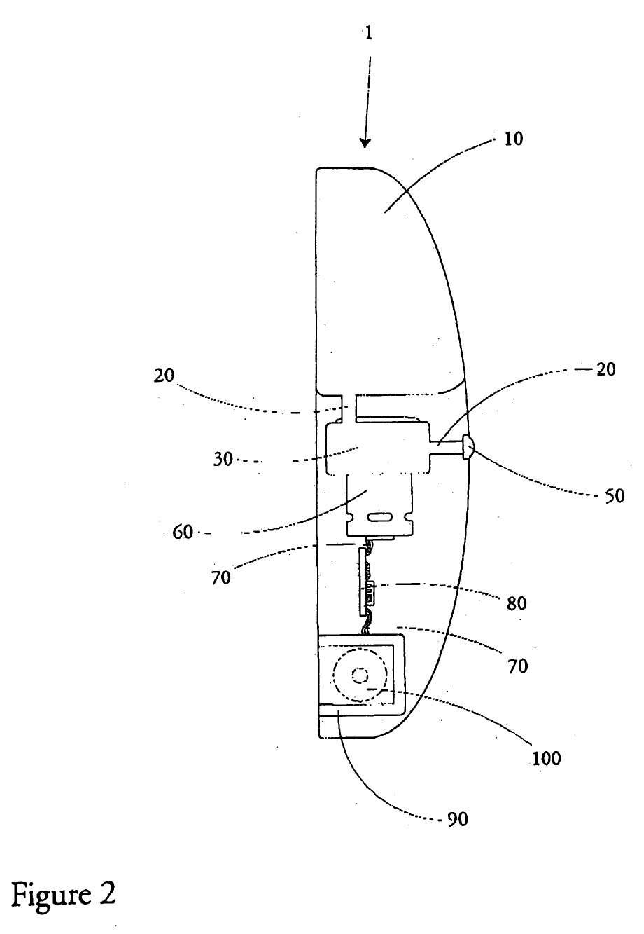

Referring to FIG. 2 the fabric article treating device 1 comprises a power source 100 for supplying power to component(s) of the device 1 such as but not limited to the circuits 80, the motor 60 for the dispensing means 30, and any other component of the fabric article treating device 1 which requires a power source 100. Suitable power sources 100 include but are not limited to household electrical current, solar power sources, and batteries. The power source 100 typically comprises one or more batteries associated with the device 1. Suitable batteries include, but are not limited to: alkaline batteries, lithium batteries, and the like. A suitable alkaline battery is an Energizer No. E95, a 1.5V Zn/MnO₂ D Cell battery which can be obtained from Eveready Battery Company of St. Louis, Mo. The batteries used herein may be either of the disposable or rechargeable type.

Source of Benefit Composition

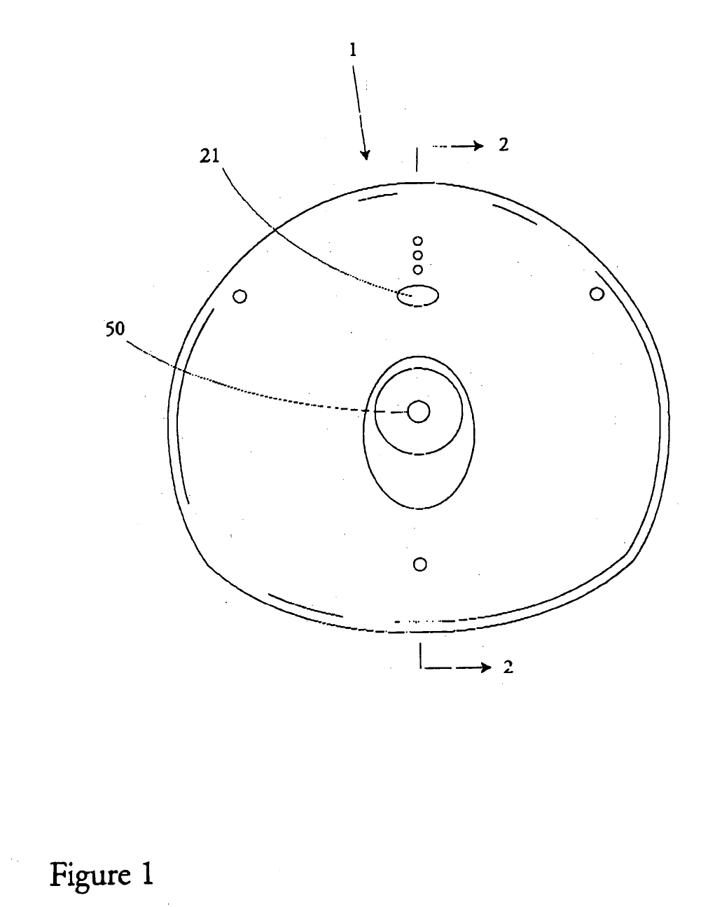

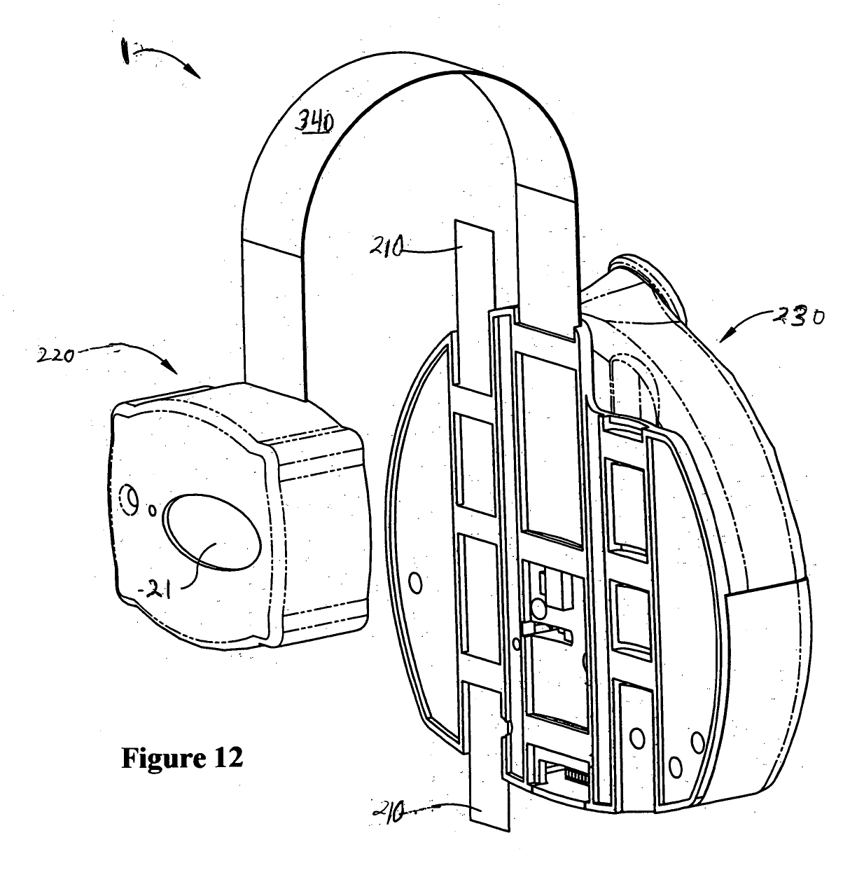

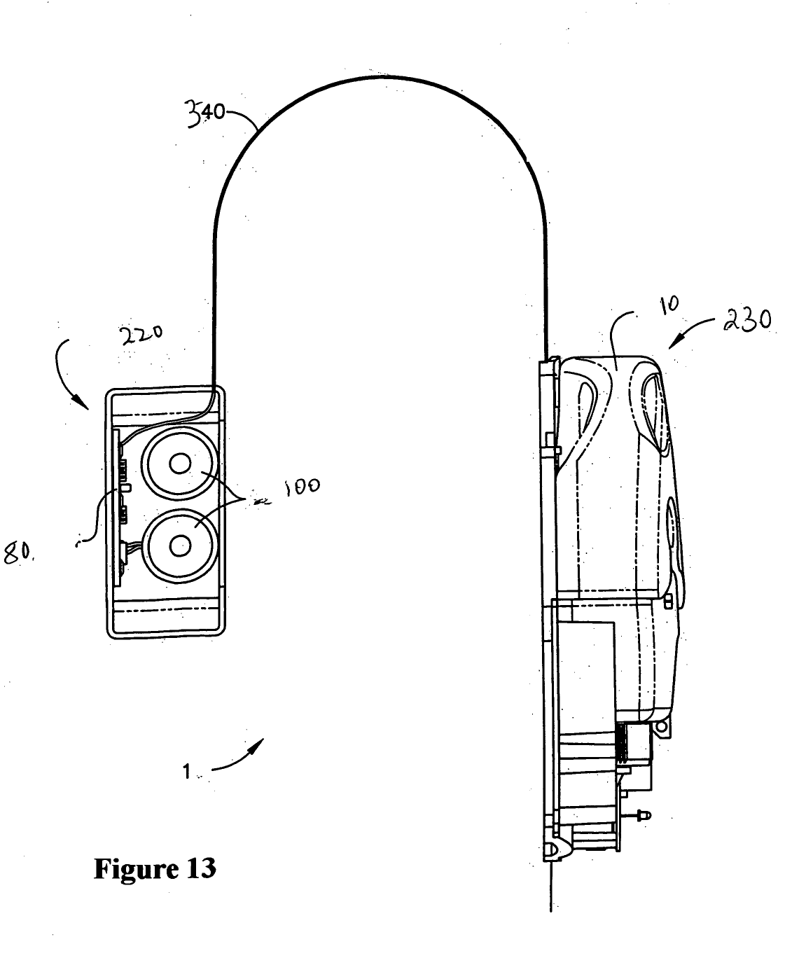

Referring to FIGS. 1-6 and 8-14, the fabric article treating device 1 additionally comprises one or more sources of a benefit composition 10. The source of the benefit composition may be a reservoir, cartridge, pouch, household water line, or the like. Additionally the source of benefit composition may be a refillable and/or non-refillable container that has a finite amount of liquid contained therein. In even another embodiment, the source of benefit composition may be both a household water line and a refillable and/or non-refillable container. The source of benefit composition may be fixably attached to the fabric article drying appliance 260 or it may be removably attached.

Referring to FIGS. 2-6, 9-11, and 13-14 the source of a benefit composition 10 may comprise a first reservoir for containing the benefit composition to contact fabric articles, and may additionally comprise more than one reservoir to be dispensed simultaneously or separately with the contents of the first reservoir. The source of the benefit composition may be constructed of a rigid, semi-rigid, and/or flexible material. Should the source of benefit composition 10 be constructed primarily of a rigid or semi-rigid material, preferred embodiments will additionally comprise a venting means so as to permit the ready flow of the benefit composition to the dispensing means 30.

Dispensing Means

Generally, the dispensing means 30 of the fabric article treating device 1 may be accomplished by utilizing a pump. The pump may be motorized or non-motorized. A non-limiting example of one suitable motorized pump isone utilizing hydraulic pressure such as a peristaltic pump. Other non-limiting examples of suitable motorized pumps includes those having motor driven pumping mechanisms such as: gear, diaphragm, centrifugal, piston pumps, and the like. Generally, a suitable pump will have an operating pressure in the range of from about 1 to about 2,000 kPas, although pressures between about 50 and about 1500 kPas, and/or from about 75 to about 1050 kPas and/or about 100 to about 500 kPas can be used.

To conserve the energy used from the power source, the dispensing means 30 may be of the non-motorized type, non-limiting examples of which include: springs, pressurized reservoirs, elastic vessels, memory shape alloys, gravity feeding mechanisms, capillary action, propellants, syringes, gas (both pre-pressurized and/or generated in-situ), ultrasonic piezo pumps, and the like. A suitable piezo pump is an “LPD series” pump and may be obtained from Par Technologies, LLC of Hampton, Va.

High Voltage Power Supply (HVPS)

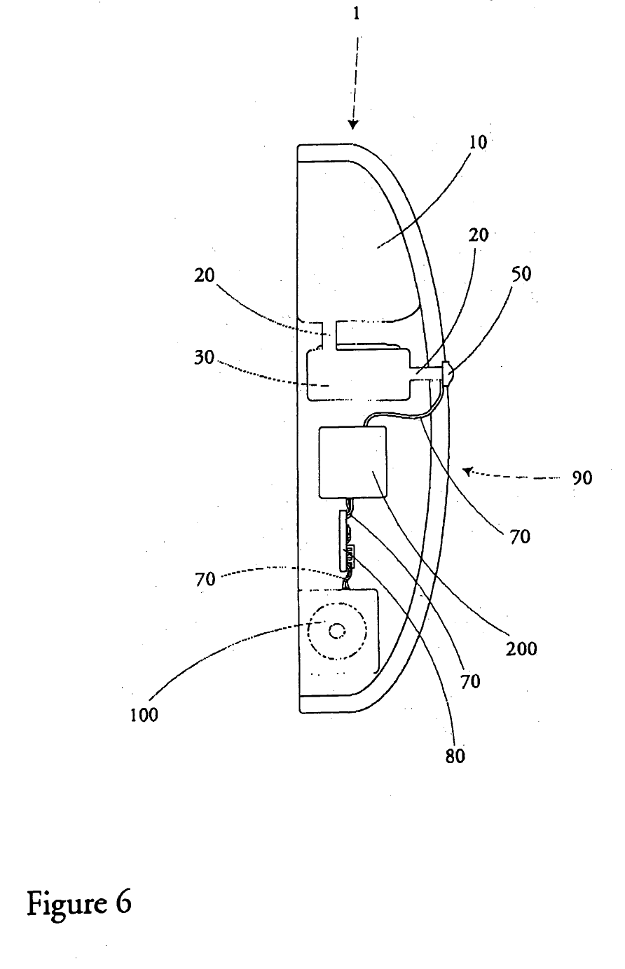

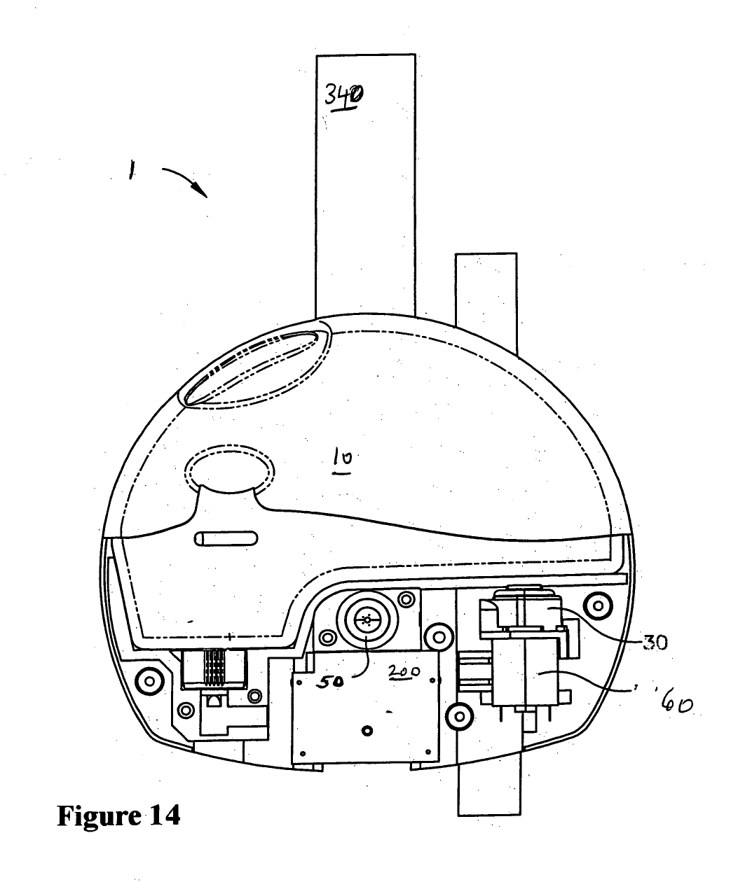

Referring to FIGS. 6 and 14, the device 1 may also comprise a high voltage power supply (HVPS) 200, which is used for transforming current in order to electrically charge the benefit composition. For electrostatic spraying, there may be an absolute difference in potential between a fabric article and the benefit composition from about 0.2 kV to about 50 kV. Typically (but not always) the power source 100 is one or more batteries with a voltage of 9V (0.009 kV) or less, which is transformed into a higher current level by the high voltage power supply 200, and the benefit composition is charged via an electrical charging component 70. In a non-limiting example, a 1.5 V battery is used and the high voltage power supply 200 produces a 5 kV charge which is provided to the benefit composition via the electrical charging component 70, although the high voltage power supply may also be used when the power source 100 is a source of household current. A non-limiting example of a suitable miniature, regulated high voltage power supply 200 is a model in the C series such as the C50, C60, or C80 which can be obtained from EMCO High Voltage Corporation located in Sutter Creek, Calif. Other suitable high voltage power supplies 200 include piezo transformers, which utilize a unique mechanical energy storage system for transforming power. These piezo transformers are of particular use when utilizing ultrasonic nebulization. Piezo transformers may be obtained from Fuji & Co. of Japan.

Grounding Means

The device may be grounded by way of being in contact with a grounded part of the fabric article drying appliance 260 non-limiting examples of which include: a spring, patch, magnet, screw, arc corona discharge, or other attaching means, and/or by way of dissipating residual charge. One way of dissipating the charge is by using an ionizing feature, for example a set of metallic wires extending away from the source of current. Should it be desired to ground to the typically enameled surface of the fabric article drying appliance 260, a pin that penetrates the non-conductive enamel paint may be used for grounding thereto. Another means of grounding to the non-conductive surface of a fabric article drying appliance 260 comprises the usage of a thin metal plate that is positioned between the fabric article drying appliance 260 and the fabric article treating device 1 which serves to provide a capacitive discharge. Typical thickness of such a plate is generally from about 5 μm to about 5000 μm.

Electrical Charging Component

Referring to FIG. 6, the device 1 may comprise an electrical charging component 70, typically an electrical field, that electrically charges the benefit composition and/or a moiety present in the benefit composition that is capable of acquiring an electric charge and optionally, capable of retaining an electric charge for a time period sufficient for the electrically charged composition to contact a fabric article(s) being treated. The source of the benefit composition 10 may also comprise a reservoir for containing the composition to be electrically charged and/or the electrically charged composition. In one embodiment, the electrical charging component is integral with the device 1. In another embodiment, the electrical charging component is separate and discrete from the device 1.

Suitable examples of devices with electrical charging components are disclosed in U.S. Ser. No. 10/418,595 filed on Apr. 17, 2003.

Nozzles

Referring to FIGS. 2-6, the device may also, and typically does, comprise a nozzle 50 through which the benefit composition passes during delivery to the fabric article. The nozzle 50 may optionally comprise an electrical charging component 70. The optional electrical charging component may be integral with the nozzle 50 as shown in FIG. 6. In another embodiment (not shown), the optional electrical charging component 70 is positioned within the source of benefit composition 10.

The device 1 may further comprise one or more atomizing nozzles for purposes of enhancing the effective distribution of the benefit composition on the fabric articles. The atomizing nozzles may be used in addition to electrostatic spraying, or may be used without electrostatic spraying. The misting of the benefit composition can be achieved using any suitable spraying device such as a hydraulic nozzle, sonic nebulizer, high pressure fog nozzle or the like, to deliver target particle sizes. However, the misting is preferably accomplished using a relatively low volume air atomization nozzle and/or a simple orifice. Non-limiting examples of suitable spray nozzles include spray nozzles commercially available from Spray Systems, Inc. of Pomona, Calif. (Model Nos. 850, 1050, 1250, 1450 and 1650). In an alternative embodiment, the composition is delivered via more than one spray nozzle.

In non-electrostatic spraying embodiments, the spray nozzle may be a pressure swirl atomizer similar to ones used in trigger sprayer nozzles, but may incorporate a fan atomizer, or an impingement or screen foamer. A suitable pressure swirl atomizing nozzle is available from Seaquist Dispensing of Cary, Ill. under the Model No. of DU-3813.

In another embodiment, the composition is delivered though a pressurized spray system. When a finer mist is used, e.g., droplets with an average particle size of less than 100 microns, the spray pattern is typically disturbed by air movement in the dryer chamber. This problem however, can be overcome by electrically charging the droplets.

Further yet, the device may comprise an adjusting component capable of controlling the orientation and/or direction of the dispensing benefit composition from the nozzle.

Still further yet, the device may comprise a shaping component capable of electrically shaping and/or charging the composition dispensing from the nozzle. The shaping component may comprise an insulating element whereby in use the first droplets to contact the insulating element generate an electrostatic field for shaping the delivery of the electrically charged benefit composition and/or a conductive element whereby in use the conductive element is charged so as to generate an electrostatic field for shaping the delivery of the electrically charged composition.

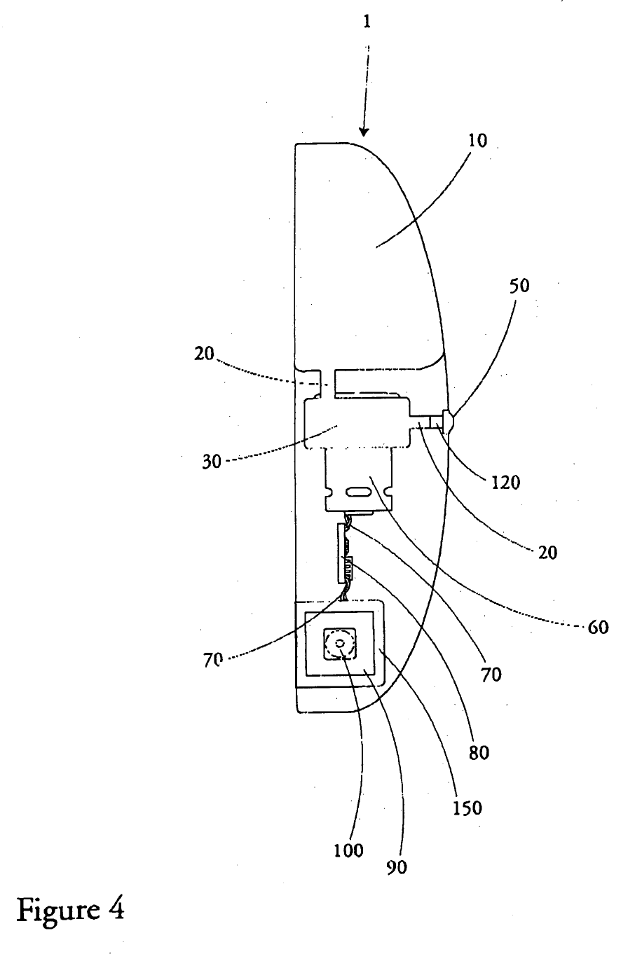

One challenge of spraying the benefit composition into the fabric article drying appliance is the possibility that the benefit composition may plug the nozzles in between uses. Several approaches can be used to prevent this plugging, including but not limited to; the usage of a filter 120 in the device 1 prior to the nozzle 50 as shown in FIG. 4, filtering the benefit composition prior to dispensing into the reservoir 10, centrifugation of the benefit composition prior to dispensing into a reservoir 10, and the like.

The design of the nozzle 50 may be such that the filter 120 and spray-head are detachable either separately or as a unit from the remainder of the assembly for the purpose of cleaning and replacement thereof. Most preferably, the filter has a pore size equal to or less than the greatest outlet diameter of the nozzle orifice.

Signaling Means

Further yet, the device may comprise a signaling means to communicate with a user of the device. Non-limiting examples of signals which may be communicated to the user include visual, auditory, vibrational signals, and the like, or combinations thereof. Non-limiting examples of signaling means include: flashing lights, colored lights non-limiting examples of which include green/red lights, beeps, whistles, chimes, and the like. The signaling means is useful for indicating the status of the device, which may in turn require the user to actuate a feature of the device.

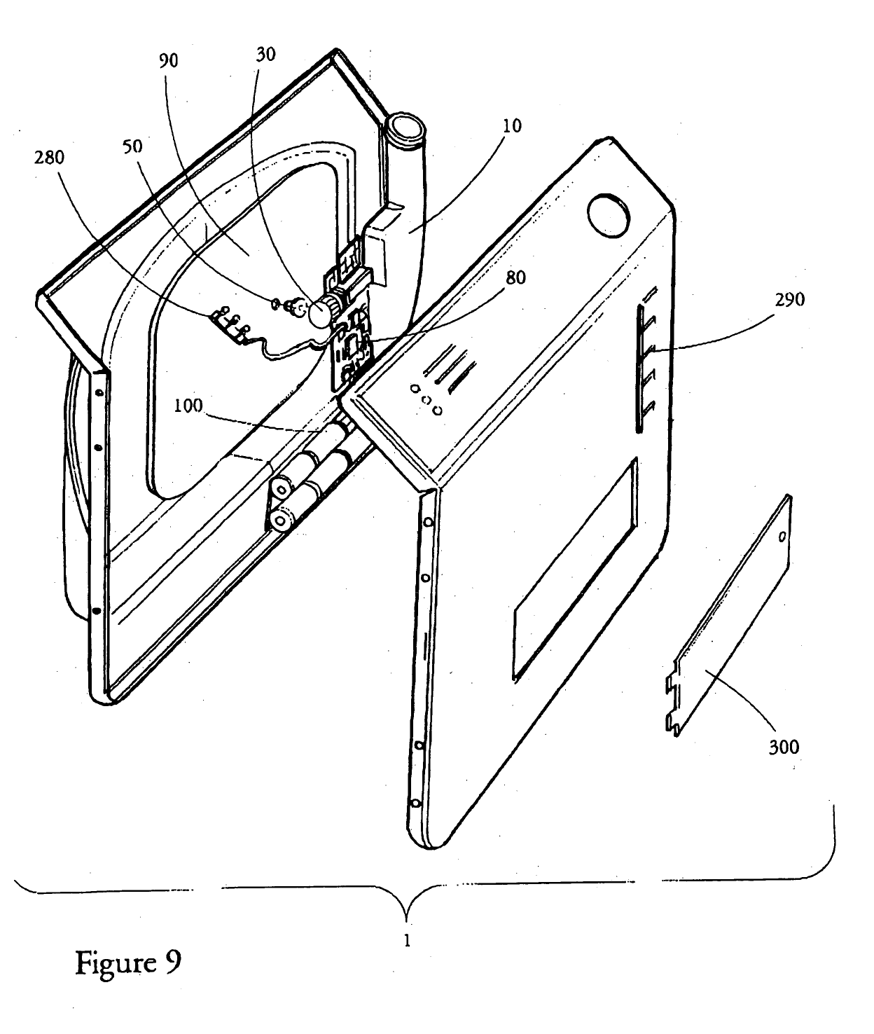

Referring to FIG. 9, a non-limiting example of signaling means are illustrated. The LED lights 280 which are visible from the exterior surface of the fabric article drying appliance door may have different colors to indicate an operating condition: inter alia a green LED light for when the device is in operation, or perhaps a flashing red light to indicate a low battery 100 state.

Benefit Composition

The benefit composition may comprise one or more fabric article actives. The benefit composition-may be in the physical form of a liquid, solid, gas, or combinations thereof.

The benefit composition may comprise water, water hardness agents, sodium chloride, sodium sulfate, sodium phosphate, calcium chloride, calcium sulfate, calcium phosphate, magnesium chloride, magnesium sulfate, magnesium phosphate, potassium chloride, potassium sulfate, potassium phosphate, solvents, surfactants, wrinkle releasing agents, anti-static agents, anti-shrinking agents, antimicrobial agents, wetting agents, crystal modifiers, soil release agents, preservatives, bleaches, auxiliary cleaning agents, anti-wrinkling agents, wetting agents, crystal modifiers, colorants, brighteners, perfume, odor reducers/eliminators, deodorizer/refresher, stain repellents, color enhancers, starch, softeners, and sizing agents, and mixtures thereof. Non-volatile mineral agents may be present in the benefit composition at a level of from about 0 ppm to about 100 ppm and/or up to about 50 ppm and/or to about 25 ppm and/or to about 10 ppm by weight of the benefit composition.

Typical fabric benefit compositions herein may comprise at least about 50%, by weight of water, preferably at least about 65%, and more preferably at least about 80% water.

One unique challenge of spraying chemistries on fabric articles in the dryer is the propensity of the benefit composition to plug spray nozzles between uses. Several approaches can be used to prevent this plugging, including but not limited to; utilizing filters as discussed above, using single phase solutions, including higher levels of humectants or other moisture retaining ingredients, hydrophilic solvents, using film softening ingredients with polymers, and the addition of hygroscopic salts in the benefit composition.

A more detailed description of the individual components of the benefit compositions, that is, the organic solvents, surfactants, perfumes, preservatives, bleaches and auxiliary cleaning agents can be found in U.S. Pat. No. 5,789,368, issued to You et al. on Aug. 4, 1998. Additionally, benefit compositions are described in U.S. Pat. No. 5,912,408, which issued to Trinh et al on Jun. 15, 1999. Anti-shrinkage agents suitable for use in this invention can be found in WO 00/11133, which published in the name of Strang and Siklosi on Mar. 2, 2000.

A. Electrically Charged Benefit Compositions

In one embodiment of the invention, the benefit composition is delivered as an electrically charged composition. “Electrically charged composition” as used herein means any composition, typically an aqueous liquid, that has an applied potential in the range of from about 0.2 to about 50 kV. The composition may have a negative charge potential, a positive charge potential, or a charge potential which oscillates therebetween. The electrically charged composition may contain a moiety capable of acquiring an electric charge and optionally, capable of retaining an electric charge for a time period sufficient for the electrically charged composition to contact a fabric article being treated by the electrically charged composition. In preferred embodiments, the absolute difference of potential between a fabric article and the electrically charged composition is from about 0.2 kV to about 50 kV.

Generally, the electrically charged benefit composition may be a conductive aqueous liquid. The liquid may have a resistivity of less than about 10⁵ Ohms*m and/or less than about 10⁴ Ohms*m and/or less than about 10³ Ohms*m and/or less than about 10² Ohms*m. However, a higher resistivity liquid can also be effectively delivered using the methods and apparatuses of the present invention.

The composition may be electrically charged at any point in time prior to contacting the fabric article. Preferably it is electrically charged prior to the time it is separated from the fabric article treating device, but it may be electrically charged after it is separated from the device.

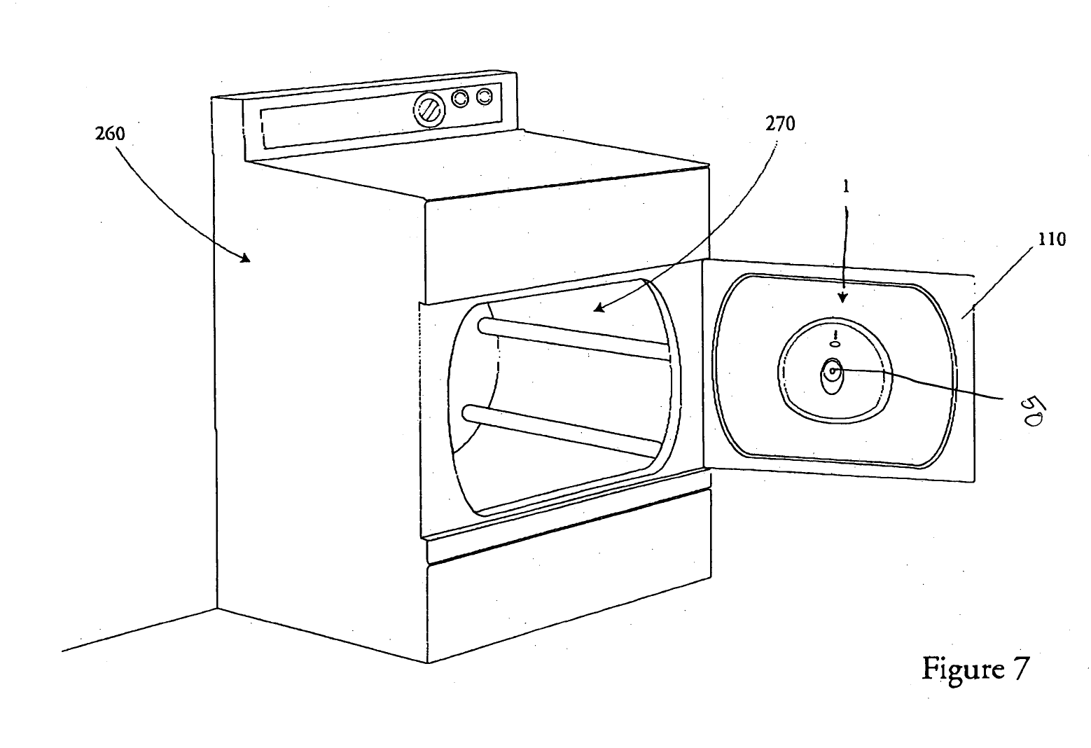

Referring to FIGS. 7-10 there is illustrated a fabric article treating system for treating one or more fabric articles according to the present invention. The fabric article treating system comprises a fabric article treating device 1 associated with a fabric article drying appliance 260 in a manner such that a benefit composition is dispensed within the fabric article drying appliance 260 thereby treating fabric articles which come into contact with the fabric article drying appliance. In one embodiment, contact with the benefit composition may occur while the fabric articles are in motion in the drying appliance 260. In another embodiment, the contact may occur while the fabric articles are not in motion. In even another embodiment, the contact may occur while the fabric articles are at one point in motion and at another point in time not in motion. Additionally, the fabrics may be in a wet or dry state upon treatment.

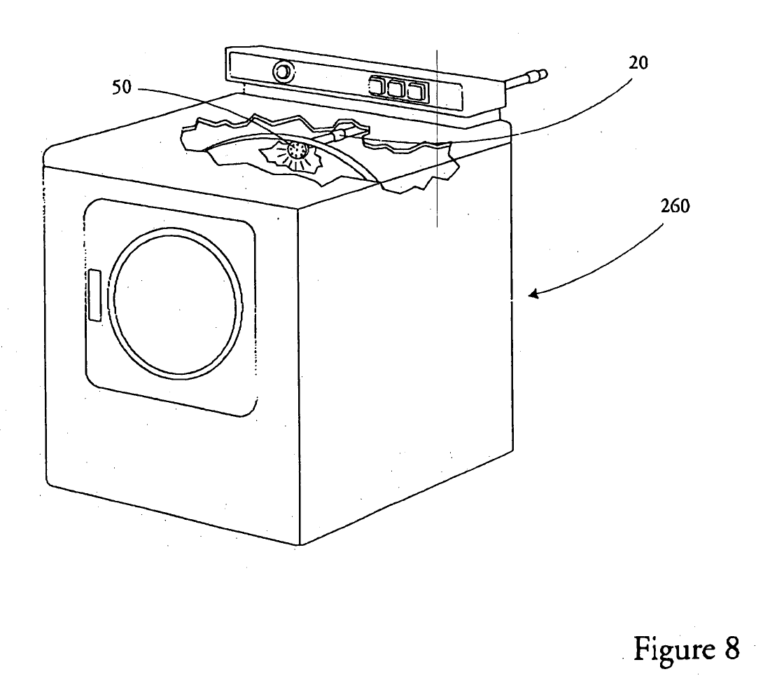

Referring to FIGS. 7 and 8, there is illustrated a fabric article treating system for treating fabric articles according to the present invention. In one embodiment as shown in FIG. 8, the fabric article treating device 1 may be integral with the drying appliance 260 such that it is incorporated as a part of the drying appliance 260. In another embodiment as shown in FIG. 7, the fabric article treating device 1 is a discrete stand-alone unit which may be attached to the drying appliance 260. The discrete stand-alone unit may be comprised of a single unit within a single enclosure as shown in FIG. 7. In yet another embodiment (not shown), the discrete stand-alone unit may comprise an inner housing which is positioned within the drying appliance and an outer housing positioned outside of the drying appliance wherein the inner housing and outer housing are connected to one another via some connection means such as but not limited to a cable, a wire, or the like. Generally, the inner housing and outer housing are in electrical communication with one another.

Referring to FIG. 7, the fabric article treating system can comprise a fabric article drying appliance 260. A door 110 can be movably connected to the fabric article drying appliance 260 for ensuring that the fabric articles to be treated remain within the fabric article receiving volume or in other words, within the drum. The fabric article treating device may be attached to any portion of the fabric article drying appliance interior 270, non-limiting examples of which include: the door 110 of the fabric article drying appliance, the drum, the back wall of the drum, and the like. Furthermore, the device 1 may be removable or permanently attached to a portion of the fabric article treating drying appliance 260 by a suitable attachment means, which include, but is not limited to: straps, magnets, Velcro®, adhesive tape, suction cups, screws, and the like.

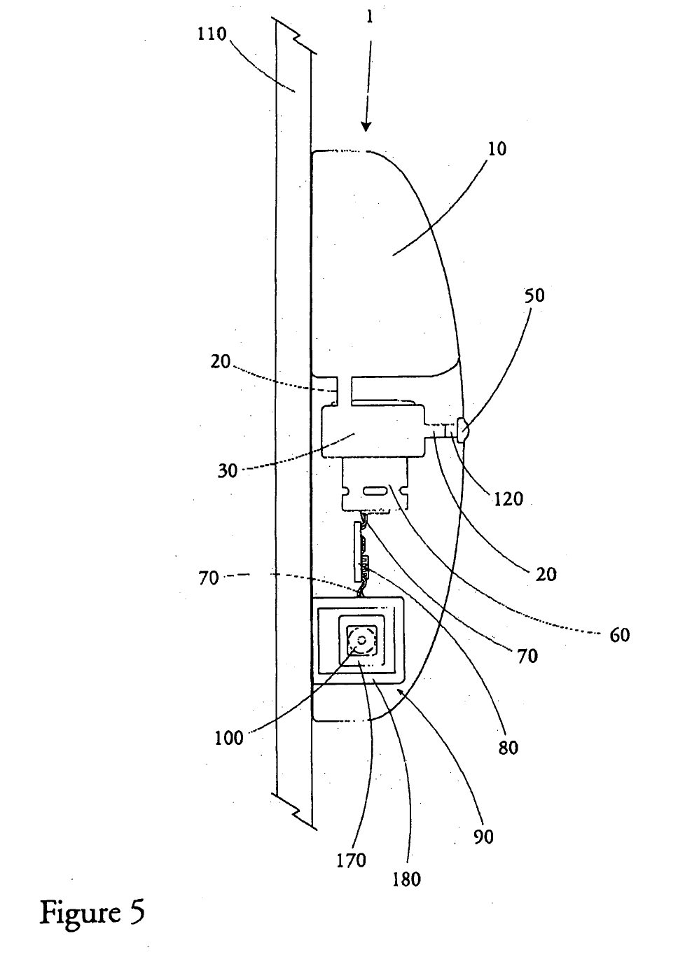

Referring to FIGS. 4 and 5, in a typical operation the power source 100 comprises one or more batteries and is enclosed by a casing 90 of a thermal protective material such as polyurethane foam. In another embodiment of the present invention, the casing is a thermal protective material constructed in whole or in part of a phase transition material such as Thermasorb® 83 by Frisby Technologies of Winston Salem, N.C. In still yet another embodiment of the present invention, the casing 90 is constructed of a material not insulating to heat such as tin, and has an outer layer of insulating paint disposed on the exterior surface. A suitable insulating paint may be obtained from Hy-Tech of Melbourne, Fla. under the tradename of Insul-Seal®. A suitable thickness for the coating is from about 0.1 mm to about 10 mm.

Connected to the power source 100 by electrical charging component 70 is an optional electronics board 80 for controlling the motor 60. The motor 60 activates the dispensing means 30 such as a peristaltic pump.

Once the pump is activated, a benefit composition is drawn from a reservoir 10 through a conduit 20. The inner diameter for the conduit may be from about 20 mm or less and more preferably ranges from about 20 mm to about 7 mm. The conduit 20 may additionally comprises a filter 120 prior to the nozzle 50.

The nozzle 50 is preferably a fluid atomizing spray head and/or even a simple orifice through which the benefit composition is dispensed within the receiving volume of the fabric article drying appliance 260.

In another embodiment of the present invention, as illustrated in FIG. 3, a casing 90 is provided with a conduit 20 through which the benefit composition may circulate and provide a cooling effect upon the power source 100 by means of heat transfer. After conveyance through conduit 20, the benefit composition then proceeds to the pump 30, through which the benefit composition is discharged through the nozzle 50. As shown in FIG. 3, reference numeral 130 refers to the outer wall of the conduit 20 while reference numeral 90 refers to the inner wall of conduit 20.

The embodiment represented by FIG. 4 operates in a similar manner to the embodiment of FIG. 2. The power source 100 has a casing 90 of a non-insulating material such as a metal, which is coated by a secondary material 150 which comprises an insulating material, such as a ceramic paint. A suitable insulating paint may be obtained from Hy-Tech of Melbourne, Fla. under the tradename of Insul-Seal®. A suitable thickness for the coating is from about 0.1 mm to about 10 mm.

The embodiment of FIG. 5 also operates in a similar manner to the embodiment of FIG. 2. The casing 90 for the power source 100 comprises two layers, in which an insulating material such as air is disposed therebetween. The first layer 170 and the second layer 180 of the casing 90 may be constructed of insulating materials, non-insulating materials, and combinations thereof.

The embodiment of FIG. 6 operates in a similar manner to those illustrated in FIGS. 2, 4, and 5. In this embodiment, a casing 90 surrounds the entire device 1. The casing may comprise a phase transition material. A non-limiting examples of a suitable phase transition material which may be used for this purpose is Thermasorb® 83 from Frisby Technologies of Winston Salem, N.C. In an alternate embodiment, the casing 90 may be constructed of a thermal protective material. A non-limiting example of a suitable phase transition material for this purpose is polyurethane. This embodiment is also designed to deliver a benefit composition into the fabric article drying appliance with a non-motorized dispensing means 30, such as a spring actuated pump. Yet further, this embodiment is also designed to deliver an electrically charged benefit composition into the drying appliance, although if it is desired to construct a more economical device without electrostatic spraying, the high voltage power source 200 and the electrical charging component 70 may be omitted.

Once the device 1 is actuated by an on/off switch 21 (as shown in FIG. 1, the electronics 80 may activate the dispensing means 30 such as a pump and the high voltage power supply 200. When the pump is activated, the benefit composition will flow from the reservoir 10 through the conduit 20 and the pump 30 through tubing 20 to the filter 120 and into the nozzle 50. At the nozzle 50, the benefit composition will be electrically charged through a wire 70 connected to the high voltage power supply 200 to create an electrostatic spray.

The fabric article treating system illustrated by FIG. 8 represents further yet an embodiment of the present invention. In this embodiment, the source of benefit composition (not shown) is a source of household water, which is conveyed through a conduit 20 to the nozzle 50, which thereby discharges the benefit composition to the interior of the fabric article drying appliance 260.

The embodiment of FIG. 9 operates in a similar manner to the device 1 of FIG. 6. In this embodiment, the device 1 is incorporated into a fabric article drying appliance door 110 such that the device 1 may be readily incorporated into a fabric article drying appliance by the simple exchange of appliance doors. This provides the convenience of an integrated system, yet without the amount of modification required in an integrated system such as that shown in FIG. 8. The batteries 100 may be readily replaced my means of an access panel 300, and the opening for the source of the benefit composition 10 is accessed through the exterior of the dryer door 110.

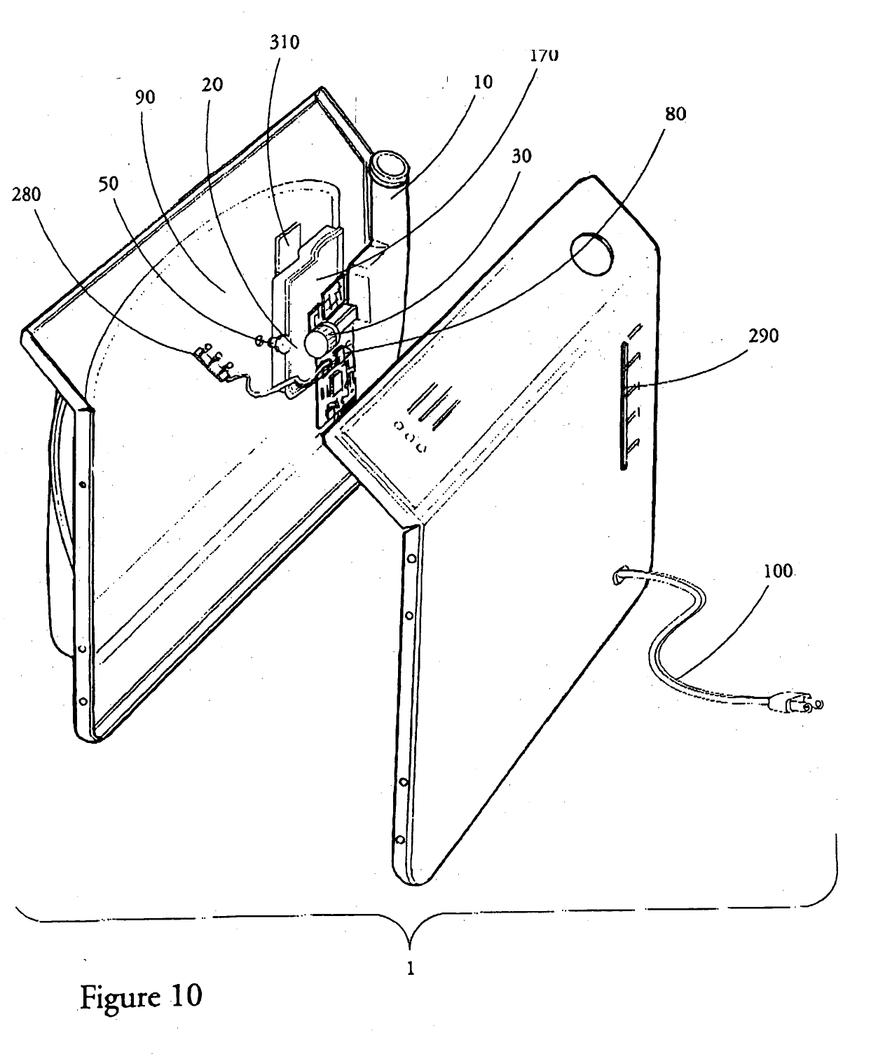

The device of FIG. 10 operates in a similar manner to that of the device represented in FIG. 9. In this device, the electronics board 80 is cooled by a thermoelectric module 310 utilizing the Peltier Effect. The power source 100 utilizes a source of household current to supply power to the thermoelectric module 310, whereby the heat is transferred away from the electronics board 80 to the exterior surface of the dryer door 110. A suitable example of a thermoelectric cooler utilizing the Peltier Effect is model 6302/127/060AX which may be obtained from Ferrotec Americal Corporation of Nashua, N.H.

In a non-limiting example of a use of the device 1 as shown in FIGS. 1 and 2, a fabric article in need of treatment is placed in the fabric article drying appliance (not shown). The drum of the drying appliance is activated in the usual way. Immediately after tumbling begins, the operator simply depresses on/off switch 21 on the device for a short period. The on/off switch 21 activates the electronics 80 to connect the batteries 100 through wire 70 and the pump motor 60.

In this particular example, a non-electrically charged benefit composition is conveyed from reservoir 10 through device 1 to conduit 20 through pump 30 and conduit 20 where it is discharged from nozzle 50 onto the clothing and/or within the drum. The benefit composition is discharged from nozzle 50 in the form of a mist. In general, the time for applying the benefit composition may be between about 0.5 to about 120 minutes, depending on the choice of cycle and the load size. While the benefit composition is being supplied into the fabric article receiving volume, a fan can be energized to circulate air within the fabric article receiving volume.

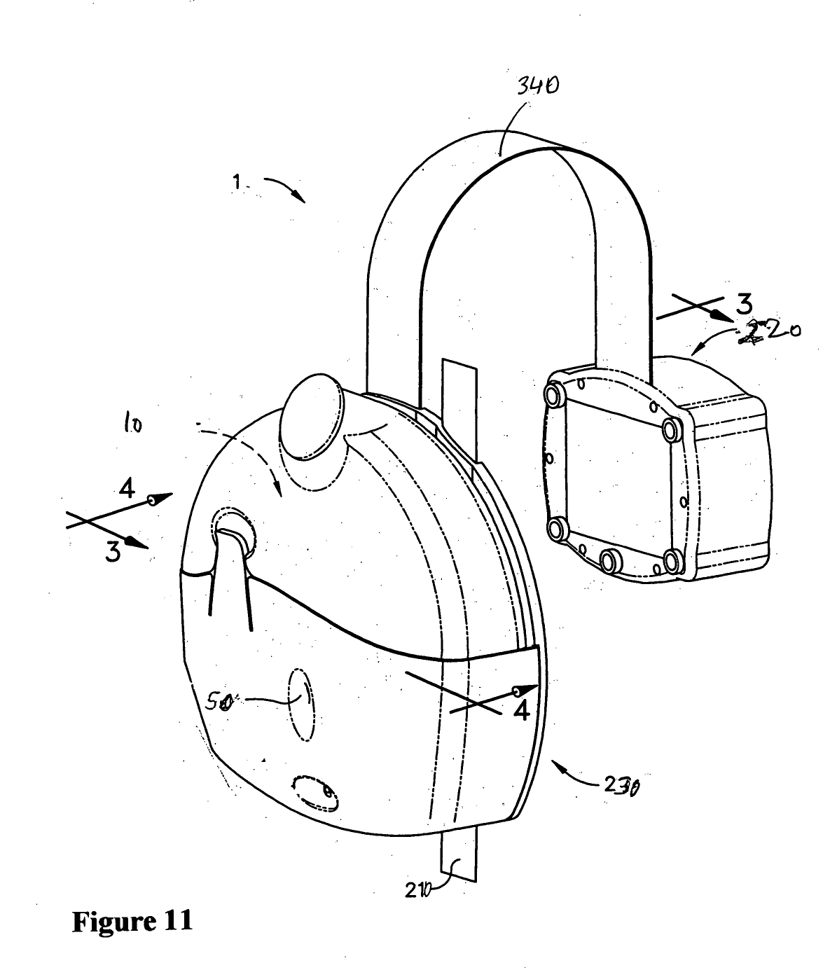

FIGS. 11-14 depict an alternate embodiment of the fabric article treating device 1. The fabric article treating device 1 comprises two housings or enclosures an inner or interior housing and an outer or exterior housing. Inner housing 230 is located in the interior of a fabric article drying appliance. Exterior housing 220 is located outside of a fabric article drying appliance. The inner housing 230 and exterior housing 220 of fabric article treating device 1 are in communication with each other. Non-limiting examples of communication between the inner housing 230 and exterior housing 220 include electrical communication (wherein electrical signals are transferred between the interior and outer housing) and compositional transfer communication (i.e.; wherein a benefit composition is transferred between the outer and inner housing), and thermal communication (i.e.; wherein temperature differentials are transferred between the outer and inner housing a non-limiting example of which is wherein the benefit composition is heated in one housing and transferred to the other housing). The inner housing 230 and exterior housing 220 may be connected to one another. Non-limiting means of connecting the inner and outer housing include a flat cable, a wire, and/or a conduit 340 (a non-limiting example of which is a conduit for transferring benefit composition between the outer and inner housing). Inner housing 230 may be mounted to the closure structure of a fabric article drying appliance by mounting strap 210.

The exterior housing 220 may be mounted on the exterior surface of the fabric article drying appliance door, yet may also be mounted on any exterior surface, non-limiting examples of which include: the side walls, the top walls, the outer surface of a top-opening lid, and the like, including a wall or other household structure that is separate from the fabric article drying appliance. Furthermore, the interior housing 230 may be mounted on any interior surface of the fabric article drying appliance, examples of which include, but are not limited to: the interior surface of the door, between the interior surface 125 and exterior surface 127 of the closure door 110 as shown in FIG. 14, the drum of the fabric article drying appliance, the back wall, the inner surface of a top-opening lid, and the like.

The interior and exterior housings may be constructed of materials familiar to those of ordinary skill in the art. Non-limiting examples of such materials include polymeric materials including but not limited to polyurethane, polypropylene, polycarbonates, polyethylene, and combinations thereof and metals including but not limited to enameled metals.

Exterior housing 220 may be permanently mounted to the exterior surface, or releasably attached to the exterior surface. Likewise, enclosure 20 may be permanently mounted to the interior surface, or releasably attached to the interior surface.

The inner housing 230 and the outer housing 220 are in communication with one another. The inner housing 230 and outer housing 220 may be connected to one another. Non-limiting examples of connecting the inner housing 220 and the outer housing 230 may include utilizing a flat cable 340 (also sometimes referred to as a “ribbon cable”) as shown in FIGS. 9-12, a wire, a wire or group of wires encased in a sheath of woven or non-woven material, a conduit (a non-limiting example of which is a conduit for the benefit composition, or a combination thereof. The woven or non-woven sheath may also be used as a method of attaching inner housing 230 and outer housing 220. The inner housing 230 and outer housing 220 may be used to provide a means of gravitational counter-balancing so as to reduce unnecessary tension on the wires and/or the housing connections. Typical weight ratios between the inner housing 230 and the outer housing 220 are generally from about 1:14 to about 14:1. The inner housing 230 and outer housing 220 may also be in electrical and/or fluidic communication. A reservoir 10 for the benefit composition, a means for protecting thermally sensitive components (one non-limiting means being inner housing 230), a pump 30, and discharge nozzle 50 are also present. The pump 30 may include a motor 60. A power supply 200 may also be included. Additional electronic components 80 may also be included.

The particular benefit composition selected for use in the process can vary widely depending upon the particular benefit desired. However, the benefit composition will contain ingredients which can be effective across a variety of fabric article types. For example, the benefit composition may be suitable for “dry-clean” only fabric articles as well as pure cotton dress shirts which typically require a significant de-wrinkling operation subsequent to conventional laundering operations (i.e. home washings and drying cycles).

Non-verbal cues may also be present within the fabric article treating system and/or device 1 to assist a user in the selection of the desired benefit composition, treatment cycle, and the like and may be present on one or more of: the device, the source of benefit composition 10, instructions, and other such articles associated with the fabric article treating system and/or device 1. While not to be bound by theory, it is believed that these non-verbal cues simplify the operation of a fabric article treating system and therefore provide convenience to a user of the system. The non-verbal cues may be visual, auditory, tactile, or vibrational, signals or may comprise combinations of these signals. Non-limiting examples of non-verbal cues include: red/green lights (stop/go indicators) 280, colored and/or flashing lights, a window on a reservoir to indicate fluid level 290, icons, beeps, whistles, a rubbery grip, and the like. An example of a visual cue would be an icon of a battery that may be present on a device display as an indication to the user that the batteries need to be replaced. In another example, a tactile cue may comprise a rubbery portion of a device to indicate where a user may comfortably grip the device.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited in the Detailed Description of the Invention are, in relevant part, incorporated herein by reference. The citation of any document is not to be construed as an admission that it is prior art with respect to the present invention.

What is claimed is:

1. A system for treating a fabrics, said system comprising:
a) a fabric article drying appliance;
b) a fabric article treating device which includes a means for thermally protecting heat sensitive components wherein said fabric article treating device is associated with the fabric article drying appliance in a manner such that the benefit composition is dispensed within the fabric article drying appliance.

2. The system according to claim 1 wherein the fabric article treating device is integrated with the fabric article drying appliance, discrete from the fabric article drying appliance, or combinations thereof.

3. The system according to claim 1 wherein the fabric article treating device is integral with a closure structure suitable for use with a fabric article drying appliance.

4. The system according to claim 1 wherein the benefit composition comprises water, solvents surfactant, wrinkle releasing/prevention agent, anti-static agent, antimicrobial agent, wetting agent, crystal modifier, soil release/prevention agent, colorant, brightener, perfume, odor reducer/eliminator, deodorizer/refresher agent, stain repellent, color enhancer, starch, softener, sizing agent, or combinations thereof.

5. The system according to claim 4 wherein the benefit composition comprises one or more fabric article actives with a thermal conductivity of about 20 W/m*° C. or greater at 25° C.

6. The system according to claim 1 wherein the benefit composition is electrically charged.

7. The system according to claim 1 further comprising a safety means wherein said safety means comprises grounding.

8. A fabric article treating device said treating device comprising:
a) one or more sources of a benefit composition;
b) a dispensing means; and
c) one or more means for thermal protection.

9. The device according to claim 8 further comprising a power source.

10. The device according to claim 8 wherein said source of benefit composition is a reservoir, a cartridge, a pouch, or combinations.

11. The device according to claim 8 wherein said dispensing means is a pump, said pump comprising:
a) a conduit wherein said conduit includes an inlet and a discharge; and
b) a nozzle connected to said discharge of said conduit. and
c) optionally a filter.

12. The device according to claim 8 wherein said dispensing means comprises a source of gravitational energy, mechanical energy, potential energy, electromechanical energy, or combinations thereof.

13. The device according to claim 8 wherein the means for thermal protection comprises a material with a thermal conductivity from about 0 to about 5 W/m*° C. at 25° C.

14. The device according to claim 13 wherein the means for thermal protection comprises a first, second, and third layer, wherein said first layer is adjacent to said second layer and said second layer is adjacent to said third layer and wherein said first layer and said third layer are positioned in exterior relation to said second layer and wherein said second layer has a thermal conductivity from about 0 to about 5 W/m*° C. at 25° C.

15. The device according to claim 14 wherein said second layer comprises a gas, a solid, a liquid, or a combination thereof.

16. The device according to claim 8 wherein the means for thermal protection comprises a conduit in thermal communication with one or more components of said device and a benefit composition, wherein said benefit composition is in association with said conduit so as to provide thermal protection to one or more components of said device.

17. The device according to claim 8 wherein the means for thermal protection is comprised in whole or in part of a phase transition material.

18. The device according to claim 8 wherein the means for thermal protection comprises thermoelectric cooling.

19. A method for treating a fabric article comprising:
a) providing a fabric article treating device having a thermal protection means;
b) providing a fabric article drying appliance;
c) placing the fabric article in need of treatment within the fabric article drying appliance; and
d) operating the fabric article treating system;

19. The method according to claim 18 further comprising drying the fabric article wherein said drying occurs subsequent to step (d), prior to step (d), in concurrence with step (d), or a combination thereof.

20. The method of claim 18 further comprising providing one or more non-verbal cues to a user of the system.

21. The method of claim 18 further comprising providing instructions for use and for selection of the benefit composition and/or a treatment cycle for a desired benefit.

22. A device for treating a fabric article within a fabric article drying appliance, said device comprising:
a) one or more sources of a benefit composition;
b) a non-motorized dispensing means; and
c) a means for thermal protection.
